(19) United States
(12) Patent Application Publication
(10) Pub. No.: US 2024/0396264 A1
(43) Pub. Date: Nov. 28, 2024

(54) CONNECTOR AND CONNECTOR SYSTEM

(71) Applicant: Tyco Electronics France SAS, Pontoise (FR)

(72) Inventors: Quentin DELESTRE, Pontoise (FR); Francois JODON DE VILLEROCHE, Pontoise (FR); Xavier ROUILLARD, Pontoise (FR); Stéphane GALLERAND, Pontoise (FR)

(21) Appl. No.: 18/664,577

(22) Filed: May 15, 2024

(30) Foreign Application Priority Data
May 26, 2023 (FR) 2305294

(51) Int. Cl. H01R 13/629; F16H 55/17

(52) U.S. Cl. CPC H01R 13/62944; F16H 55/17

(57) ABSTRACT

A connector includes an inner shell, an outer shell, and a gear wheel, wherein the gear wheel is arranged in a rack-and-pinion configuration with a first linear gear, the gear wheel being hinged on the inner shell rotatably with respect to a hinge axis orthogonal to the mating direction. The gear wheel comprises a first set of external gear teeth configured to engage with the first linear gear in the rack-and-pinion configuration, and a second set of external gear teeth configured to engage with a second linear gear of a mating connector, wherein the first set and the second set of external gear teeth are arranged in a same plane. The invention further relates to a connector system comprising the connector.

### CROSS REFERENCE TO RELATED APPLICATIONS

This application claims the benefit of FR Application No. 2305294, filed 26 May 2023, the subject matter of which is herein incorporated by reference in its entirety.

### BACKGROUND OF THE INVENTION

The subject matter herein relates to connector systems.

Connector systems are known in the art that comprise a connector, a mating connector, and a coupling system designed to facilitate the coupling of the connector and the mating connector. When the coupling is facilitated, the force, accuracy, and/or skill needed for the intended coupling of the connectors is reduced, improving user comfort and connector system reliability.

Typical coupling systems implemented in high coupling force connector systems are lever systems. In a lever system, one connector is provided with an external lever hinged on the connector housing, and the mating connector is provided with a structure configured to hook into the load-side of the lever. An alternative solution is disclosed in patent document U.S. Pat. No. 9,917,402 B1, in which the coupling system includes a conventional round-gear and a cam-gear with variable pitch radii, the cam-gear and the round-gear being in communication with each other to form a stacked-gear.

At the same time, many contemporary technical environments are further and further space-constrained, leaving less room for installation of the connectors, and less room for access to the connectors, such that the proposed enlarging coupling systems become unsuitable.

There is a need for a compact connector coupling solution, in particular for connector systems involving a high coupling force.

### BRIEF DESCRIPTION OF THE INVENTION

In one embodiment, a connector is provided configured to be coupled in a mating direction with a mating connector, and including an inner shell, an outer shell, and a gear wheel. The outer shell envelops the inner shell at least partially and is configured to be moved in the mating direction relative to the inner shell. The outer shell comprises a first linear gear arranged along the mating direction on an inner surface of the outer shell. The gear wheel is arranged in a rack-and-pinion configuration with the first linear gear and is a hinged on the inner shell rotatably with respect to a hinge axis orthogonal to the mating direction.

In various aspects, the connector is characterised in that the gear wheel comprises a first set of external gear teeth configured to engage with the first linear gear in the rack-and pinion configuration, and a second set of external gear teeth configured to engage with a second linear gear of the mating connector, wherein the first set and the second set of external gear teeth are arranged in a same plane.

In this configuration, the gear wheel facilitates the coupling of the connector with the mating connector in a more compact arrangement. As the first and the second set of external gear teeth are arranged in one plane, the gear wheel itself is kept of a smaller size and mass than known in prior art. Further, as the first and the second set of external gear teeth are configured to engage respectively with a linear gear of the outer shell and a second linear gear of the mating connector, the linear gears can also be arranged in said, reducing the overall cross-sectional size of the connector.

Additional optional features and the various aspects of the connector will be described in the following. The features and aspects can be freely combined amongst each other, yielding further possible embodiments or aspects of the inventive connector.

In one aspect of the connector, the first pitch radius of the first set of external gear teeth can be different from the second pitch radius of the second set of the external gear teeth. The pitch radius of the gear wheel is the distance between the gear wheel centre and the pitch point of the gear, that is, the point of contact of meshed teeth of the gear. With different pitch radii, advantageous leverage can be obtained, facilitating the coupling.

In one aspect of the connector, the first pitch radius can be greater than the second pitch radius. In accordance with the law of the lever, the coupling force applied on the second linear gear by the second set of external gear teeth, that is, the gear wheel output force, is thus increased, with respect to the force applied on the outer shell, that is the gear wheel input force.

In one aspect of the connector, the first pitch radius can be between 1.2 and five times, in particular 1.5 to three times, greater than the second pitch radius. Accordingly, the output force can be increased by said factor of 1.2 to five, in particular 1.5 to three. This factor provides an advantageous balance between force multiplication, gear wheel compactness and gear wheel structural stability.

In one aspect of the connector, the teeth of the first set and the teeth of the second set can have the same pitch angle and/or circular thickness and/or face width. The pitch angle is the angle comprised between the pitch points of two successive gear teeth of the gear wheel. The circular thickness is the thickness of the gear teeth at the pitch point, in a plane orthogonal to the hinge axis. The face width is the width, that is, extension, of the gear teeth along a direction parallel to the hinge axis. This improves torque transmission between the first set of external gear teeth engaged with the linear gear of the outer shell and the second set of external gear teeth engaged with the second linear gear of the mating connector.

In one aspect the connector, the teeth of the first set and the teeth of the second set can have the same dimensions. The manufacturing of the gear wheel and the linear gears of the connector of the mating connector, for example the injection moulding, is thus simplified, and the cost-efficiency of the components increased.

In one aspect of the connector, the inner shell can be configured to mate a housing element of the mating connector, and the inner shell comprises a recess extending along the mating direction, the recess being configured to receive the second linear gear of the mating connector when the inner shell is mated with the housing element, such that the second set of external gear teeth can engage with the second linear gear. Thus, the connector can receive the second linear gear of the mating connector in a configuration suitable for the engagement with the second set of external gear teeth, without increasing the cross-sectional size of the connector.

In one aspect of the connector, the gear wheel can comprise at least one gear teeth flap. A gear teeth flap is a radial projection extending beyond the gear wheel circumference in conjunction with the gear teeth along the same angular region of the gear wheel circumference, but axially displaced with respect to the hinge axis, so as not to impede the gear teeth engagement. The gear teeth flap strengthens the structural integrity of gear teeth which can be at risk when high coupling forces are involved.

In one aspect of the connector, the gear wheel can comprise a first gear teeth flap in the angular region of the gear wheel corresponding to the first set of external gear teeth, and a second gear teeth flap in the angular region of the gear wheel corresponding to the second set of external gear teeth. Thus, both the first set and the second set of external gear teeth are structurally strengthened with respect to the gear wheel.

In one aspect of the connector, the second flap is arranged on an opposing side with respect to the first flap. That is, the first flap in the second flap are arranged on mutually opposing sides of the gear wheel along the hinge axis. This improves the balance of the gear wheel axially.

In one aspect of the connector, the first flap can be arranged on the side of the first set of external gear teeth opposed to an inner surface of the outer shell, and the second flap can be arranged on the side of the second set of external gear teeth opposed to an outer surface of the inner shell. In this configuration, the guiding of the engagement of the first set of external gear teeth with the linear gear of the outer shell is improved and protected from interference by the first flap. In a corresponding fashion, the guiding of the engagement of the second set of external gear teeth with the second linear gear can be improved and protected from outside interference by the second flap.

In one aspect of the connector, the outer shell can be configured to be moved relative to the inner shell from a first uncoupled position to a second position in which the connector is coupled to the mating connector, and the inner shell comprises a protrusion formed on an outer surface of the inner shell on which the gear wheel is hinged, and the gear wheel comprises a depression matching the protrusion and configured to receive the protrusion in the first position. According to this aspect, the outer shell can be stabilised with respect to the inner shell in the first position by action of the frictional engagement of the protrusion of the inner shell in the gear wheel depression. This improves handling of the connector, as a frictional resistance must be overcome to move the outer shell with respect to the inner shell and initiate the coupling with the mating connector.

In one aspect of the connector, the gear wheel can comprise at least one cut-out region. This allows for the mass and material cost of the gear wheel to be reduced, in particular in angular zones around the gear wheel center, in other words “pie slices”, which are not structurally needed.

In one aspect the connector, the at least one cut-out region is comprised in an angular region of the gear wheel between the first and the second set of teeth. This can free up an angular movement path for the protrusion (formed on an outer surface of the inner shell) in the gear wheel, once the protrusion is moved out of the depression and the coupling is initiated. In other words, friction between the gear wheel and the protrusion is reduced and the rotation of the gear wheel is facilitated.

In one aspect of the connector, the cut-out region can be an entirely hollowed out region. The mass and material cost of the gear wheel thus be even further reduced.

In one aspect of the connector, the gear wheel can be interposed between the inner shell and the outer shell. The gear wheel that is thus interposed is enveloped by the outer shell and not external accessible, reducing the risk of wrongful manipulation or damage to the gear wheel. This can enhance the reliability of the coupling system.

In one aspect of the connector, the gear wheel can be interposed between the inner shell and the outer shell in a plane parallel to the mating direction. This can reduce the minimal distance between the outer surface of the inner shell and the surface of the outer shell, further increasing compactness.

In one aspect of the connector, the connector can comprise a connector position assurance device (CPA) configured to lock the relative position of the outer shell along the mating direction with respect to the inner shell in the second position. The CPA is moveably arranged with respect to the outer shell from an unlocked position to a locked position. The CPA is arranged in the outer shell such that a one distal extremity of the CPA is located in a receiving pocket formed in the outer shell of the connector, and the another distal extremity opposed to the one distal extremity is located outside of the receiving pocket. The CPA comprises a locking nose. A corresponding locking notch is formed on an outer surface of the inner shell, and is configured to receive the locking nose, when the outer shell is in the second, coupling, position with respect to the inner shell, and the CPA is moved with respect to the outer shell into the locked position. A thus configured CPA provides a locking function for the connector when it is coupled with a mating connector, while preserving the compactness of the assembly.

In one aspect of the connector, the ratio of the first pitch radius over the second pitch radius corresponds to the ratio of the number of external gear teeth in the first set over the number of external gear teeth in the second set. This allows for improved distribution of the action of the coupling forces over respective gear teeth engagements, thus smoothing force transmission by avoiding unsuitably high load on individual teeth.

In one aspect of the connector, the inner shell or the outer shell can comprise a linear cam extending along the mating direction, and the respectively other one of the inner shell and the outer shell further comprises a projection configured as a corresponding cam follower for the linear cam, and the moving of the outer shell relative to the inner shell comprises a sliding of the projection along the linear cam. The linear cam and the corresponding projection can provide a sliding that advantageously guides and stabilises the moving of the outer shell with respect to the inner shell.

In one aspect of the connector, the connector can be an electrical connector. Further, the inner shell of the electrical connector can house at least one electrical terminal, in particular an electrical terminal configured for electrical voltages of 400V or more. The electrical connector can benefit from above-described compactness and thus be suited for electrical applications in tight spaces, in particular in the context of electrical vehicle charging inlet connections or battery connections.

In another embodiment, a connector system is provided including the connector according to any one of the above-described aspects, and a mating connector. The mating connector comprises a housing element configured to mate the inner shell, the housing element comprising a second linear gear formed on an outer surface of the housing element, the second linear gear being configured to engage with the second set when the connector and the mating connector are coupled. The connector system benefits from the compactness and structural simplicity of the above-described connector having a gear-wheel-based coupling system in which two sets of teeth arranged in a same plane. As the sets of teeth are arranged in a same plane, the mating connector does not require any further component. The risk of increasing the cross-sectional size of the connector defined by the outer shell is thus reduced, and the connector system is more compact, in particularly more suited for tight spaces, than prior art connectors having cumbersome coupling solutions such as levers.

### BRIEF DESCRIPTION OF THE DRAWINGS

The above-described aspects, objects, features and advantages of the present invention will be more completely understood and appreciated by careful study of the following more detailed description of an exemplary embodiment of the invention, taken in conjunction with accompanying drawings, in which:

FIG. 1 illustrates a connector according to an exemplary embodiment prior to coupling with a mating connector.

FIG. 2A illustrates the gear wheel of the connector of FIG. 1.

FIG. 2B illustrates an alternative gear wheel for a connector according another embodiment.

FIG. 3A illustrates the connector of FIG. 1 during the coupling with the mating connector.

FIG. 3B illustrates the connector of FIG. 1 in a coupled but unlocked state.

FIG. 3C illustrates the connector of FIG. 1 in a coupled and locked state.

### DETAILED DESCRIPTION OF THE INVENTION

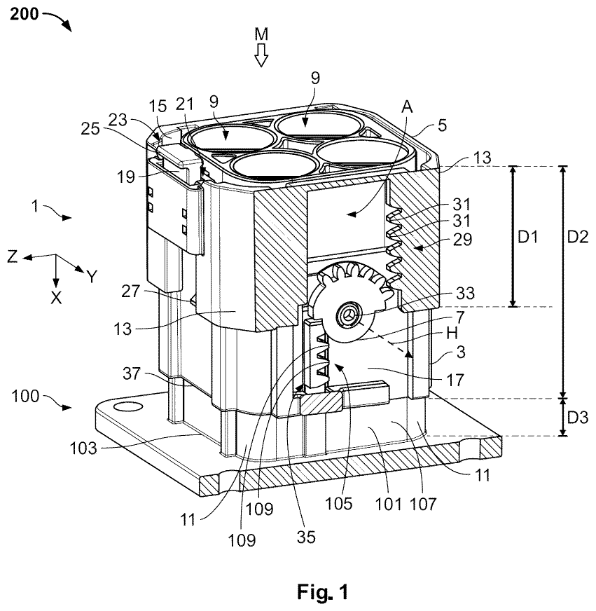

Unless explicitly described otherwise, the structural features of the objects illustrated in FIGS. 1 to 3C are not drawn to scale, neither individually with respect to their Cartesian dimensions, nor with respect to each other along one Cartesian direction. Further, identical reference signs used in different figures relate to identical elements.

In the following detailed description of FIGS. 1 to 3C, the connector 1 according to an exemplary embodiment and the connector system 200 according to an exemplary embodiment shall be described together.

FIG. 1 shows the connector system 200, comprising the connector 1 and a mating connector 100. In the view of FIG. 1, the connector 1 and the mating connector 100 are illustrated in a preliminary state, prior to a coupling and locking of the connectors.

The connector 1 comprises an inner shell 3, an outer shell 5, and a gear wheel 7. For illustration purposes, in FIG. 1, a cross-sectional portion of the outer shell 5 is removed (or rendered transparent) to allow visual access to the area A comprising the gear wheel 7 and further elements that will be described in the following.

In the present embodiment, the connector 1 is an electrical connector, and the mating connector 100 is an electrical header counter connector. The connector 1 comprises four electrical terminals (not represented) housed in four respective terminal cavities 9. The connector 1 and the mating connector 100 are power connectors for electrical vehicles and are configured for high-voltage electrical connections, for example with electrical voltages of 400V or more.

The connector 1 is configured to be coupled with the mating connector 100 in the mating direction M parallel to a first Cartesian direction X. In the present embodiment, the connector 1 including the inner shell 3 and the outer shell 5, as well as the mating connector 100, have a quadratic cross-section in the plane Y-Z perpendicular to the mating direction M. The edges 11 parallel to the mating direction M of the inner shell 3 are rounded, while the edges 13 parallel to the mating direction M of the outer shell 5 are chamfered.

The outer shell 5 envelops partially the inner shell 3. In particular the outer shell 5 surrounds the entire circumference of the inner shell 3 in the plane Y-Z perpendicular to the mating direction M, along an extension D1 along the mating direction M smaller than the extension D2 of the inner shell 3. Thus, the outer shell 5 comprises an inner surface 15 at least partially face-to-face with the outer surface 17 of the inner shell 3.

The connector 1 further comprises a connector position assurance device (CPA) 19 for the locking in position of the connector 1 when it is fully and correctly coupled with the mating connector 100. The CPA 19 is arranged in a pocket 21 formed in the outer shell 5 and extending along the mating direction M, so as to be movable with respect to the outer shell 5 in the pocket 21 between an unlocked position and a locked position. In the view of FIG. 1, as the connector 1 is yet uncoupled with the mating connector 100, the CPA 19 is also in an unlocked position.

The CPA 19 comprises, in the mating direction M, a first distal extremity 23 and a second distal extremity (not visible) opposed to the first distal extremity 23. The CPA 19 is arranged in the pocket 21 such that in both the unlocked position and the locked position, the first distal extremity 23 remains outside the pocket 21 and the second distal extremity remains inside the pocket 21.

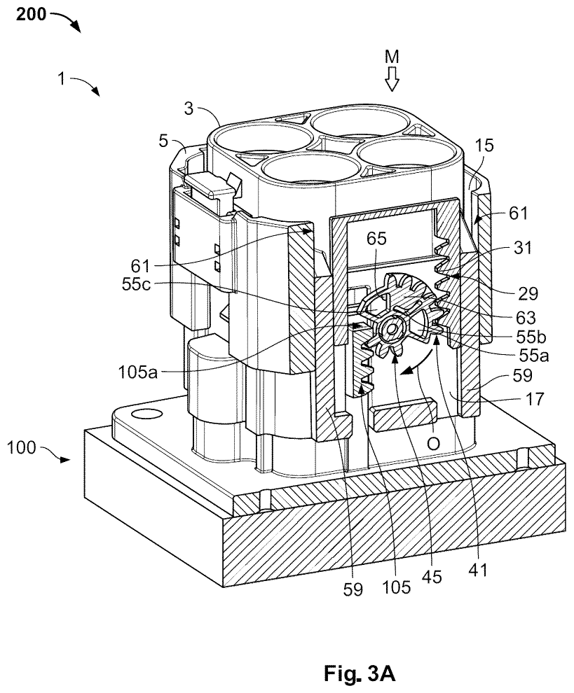

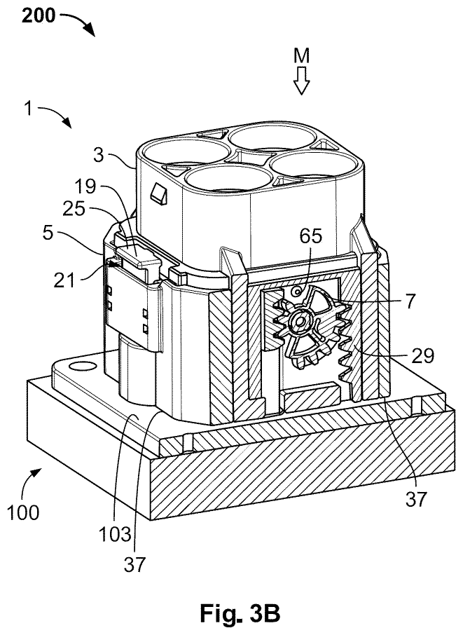

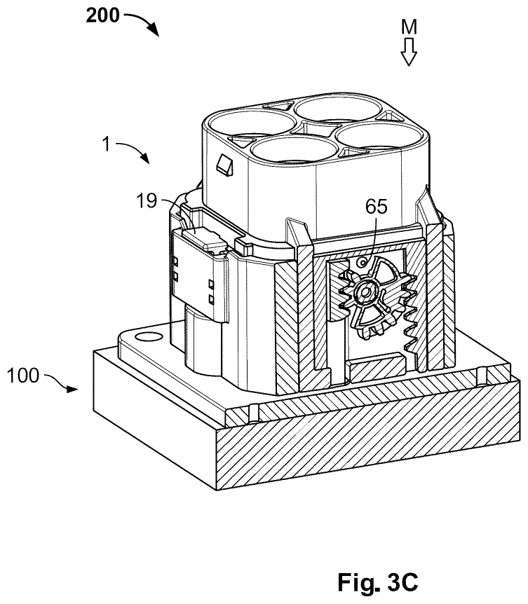

The first distal extremity 23 of the CPA 19 comprises an actuation grip 25. The actuation grip 25 is configured to facilitate manual movement of the CPA 19 in the pocket 21 and is formed to protrude outwardly, with respect to the inner shell 3. A locking nose (not visible) is formed at the second distal extremity of the CPA 19 so as to protrude inwardly, facing the outer surface 17 of the inner shell 3. A corresponding locking notch 27 is formed on the outer surface 17 and is configured to receive the locking nose, when the coupled connectors 1, 100 are a locked (see FIGS. 3B, 3C).

The area A revealed in FIG. 1 shows that the outer shell 5 comprises a first linear gear 29. The first linear gear 29 is formed on the inner surface 15 of the outer shell 5, extending along the mating direction M. Specifically, the first linear gear 29 is formed such that the teeth 31 of the first linear gear 31 are oriented in parallel to the inner surface 15 of the outer shell 5 and the outer surface 17 of the inner shell 3, such that the first linear gear 29 is interposed, or sandwiched, parallelly between inner and outer shell 3, 5. This will be further described with respect to FIGS. 3A to 3B.

The housing element 101 of the mating connector 100 comprises a similarly arranged second linear gear 105 extending along the mating direction M. The second linear gear 105 is formed on the outer surface 107 of the housing element 101 such that the teeth 109 of the second linear gear 105 are oriented in parallel to the outer surface 107 of the housing element 101.

The area A also shows that the gear wheel 7 is hinged on a hinge shaft 33 formed on the outer surface 17 of the inner shell 3 and extending along a hinge axis H orthogonal to the mating direction M. The gear wheel 7 is hinged on the hinge shaft 33 so as to be rotatable with respect to the hinge shaft 33 and the hinge axis H, and, as will be further described in the following, such that the gear wheel's 7 teeth can engage with the first linear gear 29 and the second linear gear 105.

As will be further explained and illustrated in the following, the outer shell 5 is movable with respect to the inner shell 3 along the mating direction M between an uncoupled position and a coupled position. In the presently described FIG. 1, the connector 1 has been moved in the vicinity of the mating connector 100 and the inner shell 3 has been mated with a matching housing element 101 of the mating connector 100. Specifically, the inner shell 3 has been plugged over the housing element 101 such that the second linear gear 105 is received in a recess 35 formed in the inner shell 3 extending along the mating direction M.

However, the distal edge 37 in the mating direction M of the inner shell 3 housing the terminals is still spaced apart by a distance D3 from the corresponding abutment 103 of the mating connector 100. The respective terminals of the connector 1 and the mating connector 100 are thus not in the intended contact position, and the connector system 200 is uncoupled, until the distance D3 is overcome.

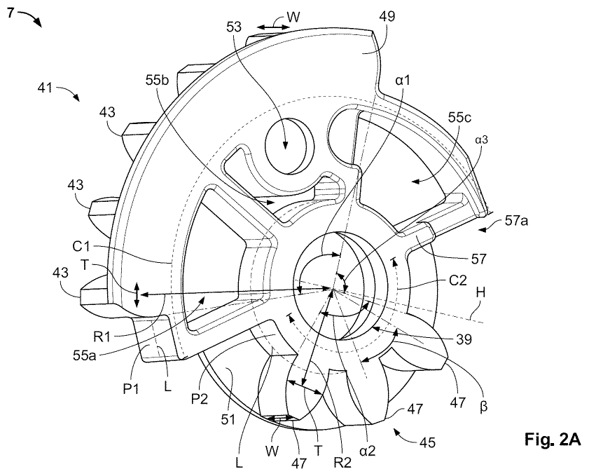

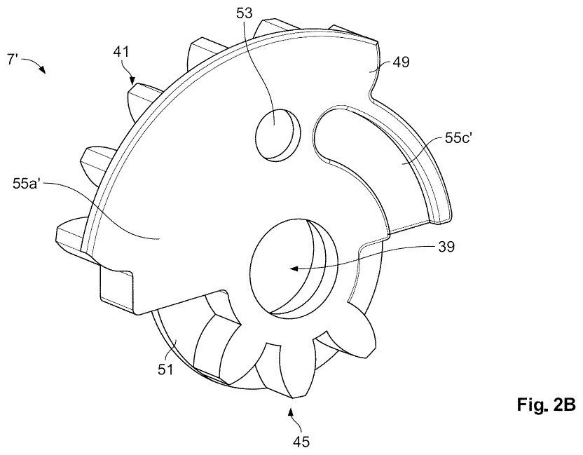

The gear wheel 7 of the above-described connector system 200 will now be described with reference to FIG. 2A. FIG. 2A illustrates the gear wheel 7 alone, in a perspective view. In the present embodiment, the gear wheel 7 is a monolithic injection moulded piece having a central through hole 39. The central through hole 39 is configured to receive the hinge shaft 33 and extends along a central axis corresponding to the hinge axis H when assembled in the connector 1. The gear wheel 7 comprises a first set 41 of external gear teeth 43, and a second set 45 of external gear teeth 47. The teeth 43 of first set 41 are configured to engage with the first linear gear 29, and the teeth 47 of the second set 45 are configured to engage with the second linear gear 105.

The first set 41 of external gear teeth 43 is arranged at a first pitch radius R1 and along a first peripheral surface P1, the peripheral surface P1 defining a first hemi-circle C1 around the hinge axis H. Similarly, the second set 45 of external gear teeth 47 is arranged at a second pitch radius R2 and along a second peripheral surface P2, said peripheral surface P2 defining a second hemi-circle C2 around the hinge axis H. The first hemi-circle C1 in the second hemi-circle C2 correspond to two opposing halves of the gear wheel 7.

In accordance with an exemplary embodiment, the first set 41 of external gear teeth 43 and the second set 45 external gear teeth 47 are arranged in a same plane, for example the plane defined by the median line L. Here, the median line L is the line separating the gear wheel 7 in two halves of equal thickness along the hinge axis H.

In other words, the planes in which the first set 41 of teeth 43 is arranged match the planes in which the second set 45 of teeth 47 is arranged. That is, all gear teeth 43, 47 of the gear wheel 7 extend along the same range along the hinge axis H. The first set 41 of teeth 43 and the second set 45 teeth 47 are arranged in the same axial region of the gear wheel 7.

The distinguishing gear wheel 7 allows for a single device to assure advantageous torque transmission for coupling facilitation, wherein the device is structured to be particularly compact and light in comparison to prior art coupling solutions.

In the present embodiment, the value of the first pitch radius R1 is double the value of the second pitch radius R2. Further, the first set 41 comprises six external gear teeth 43, arranged along the first peripheral surface P1 in a first angular region α1 around the hinge axis H. The second set 45 comprises three external gear teeth 47, arranged along the second peripheral surface P2 in a second angular region α2 around the hinge axis H. In addition, the teeth 43, 47 of the first set 41 and the second set 45 have the same dimensions, in particular the same pitch angle β, the same circular thickness T, in the same face width W.

In variants, the first pitch radius R1 can be 1.2 times greater, or five times greater, or any value therebetween, than the second pitch radius R2. Preferably, the first pitch radius R1 is 1.5 to three times greater than the second pitch radius R2. However, for improved torque transmission and compactness, it is advantageous that the ratio of the first pitch radius over the second pitch radius corresponds to the ratio of the number of external gear teeth in the first set over the number of external gear teeth in the second set.

The gear wheel 7 comprises a first gear teeth flap 49 and a second gear teeth flap 51. The first flap 49 protrudes outwardly from the first peripheral surface P1 along the first angular region α1, adjacently to the teeth 43 of the first set 41. Correspondingly, the second flap 51 protrudes outwardly from the second peripheral surface P2 along the second angular region α2, adjacently to the teeth 47 of the second set 45.

The first flap 49 is arranged adjacently to the teeth 43 on the side opposed to the inner surface 15 of the outer shell 5. The second flap 51 is arranged adjacently to the teeth 43 on the side opposed to the outer surface 17 of the inner shell 3. The flaps 49, 51 cover at least one side of their respective gear teeth sets 41, 45, improving structural stability and guidance of the respective engagement with the linear gears 29, 105.

A depression 53 is formed in the gear wheel 7 in the first angular region α1 and is configured to receive a corresponding protrusion 65 formed on the outer surface 17 of the inner shell 3. The protrusion 65 is not visible on FIGS. 1 and 2A, but visible on FIGS. 3A and 3B. The functionality of the depression 53 and the corresponding protrusion 65 will become clearer in view of FIGS. 3A to 3C and the description thereof.

To reduce the gear wheel 7 mass and material cost, some radial regions between the central through hole 39 and the first peripheral surface P1 are cut-out, that is, hollowed out. In the present embodiment, the gear wheel 7 comprises three cut-out radial regions 55a, 55b, 55c in the first hemi-circle C1. In this embodiment, the cut-out regions 55a, 55b, 55c are entirely hollowed out, that is, traverse, the body of the gear wheel 7. In variants, some or all of the cut-out regions 55a, 55b, 55c can only partially hollowed.

The radial regions 55a and 55b are comprised in the first angular region α1. The radial region 55c is substantially comprised in an angular region α3 of the gear wheel 7 between the first angular region α1 and the second angular region α2. The region 55c is configured to receive the protrusion 65 when it is dislodged out of the depression 53 and facilitates the rotation of the gear wheel 7 with respect to the inner shell 3, by avoiding excessive friction with the protrusion 65.

As an optional feature, the gear wheel 7 can comprise a wheel spoke element 57 having in a radial direction of the wheel 7 a predetermined shape, for example a step shape 57a. The step shape 57a is arranged in an area of initial engagement with the second linear gear 105. When the predetermined shape is adapted to the shape of the tip 105a (see FIG. 3A) of the second linear gear 105 to be received in the recess 35 and the inner shell 3, an additional foolproofing of the initiation of the coupling by rotation of the gear wheel can be obtained.

An alternative gear wheel 7′ is illustrated in FIG. 2B. The gear wheel 7′ is a gear wheel suitable for a connector according to another embodiment, and/or for a connector system according to another further embodiment. For example, the gear wheel 7′ can be a gear wheel for a connector that differs from connector 1 only with respect to the configuration of the gear wheel. The gear wheel 7′ can also be a gear wheel for a connector system that differs from connector system 200 only with respect to the configuration of the gear wheel. In comparison to the gear wheel 7, the gear wheel 7′ requires more material, but is also more dense and the more mechanically robust. It therefore has a greater reliability and durability.

The gear wheel 7′ differs from the gear wheel 7 in that the gear wheel 7′ only with respect to the cut-out radial regions. Thus, the gear wheel 7′ also comprises the central through hole 39, the depression 53, the flaps 49, 51, and the sets of teeth 41, 45. However, the gear wheel does not comprise the same cut-out radial regions 55a, 55b, 55c as the gear wheel 7. Specifically, instead of the cut-out radial regions 55a and 55b, the gear wheel 7′ comprises a solid region 55a′ that is monolithic with the rest of the gear wheel 7′. Instead of the cut-out radial region 55c, the gear wheel 7′ comprises the cut-out region 55c′.

The cut-out region 55c′ is reduced, in particular substantially reduced, in area in the plane orthogonal to the hinge axis H, in comparison to the cut-out radial region 55c. Specifically, the cut-out region 55c′ has an area in the plane orthogonal to the hinge axis H cut-out region 55c′ that corresponds to the minimal area necessary to receive a protrusion, such as protrusion 65, when it is dislodged out of the depression 53, and to facilitate the rotation of the gear wheel 7′ with respect to the inner shell of the connector. In the following, the coupling and locking of the connector system 200 will be described with reference to FIGS. 3A, 3B and 3C. The view of FIGS. 3A to 3C is the perspective view of FIG. 1, with the distinction that the outer shell 5 is partially sectioned along the median line L of the gear wheel 7 indicated on FIG. 2A.

FIG. 3A shows the connector system 200 during an intermediary stage of the coupling sequence between the connector 1 and the mating connector 100. After the inner shell 3 has been mated with the housing element 101 of the mating connector 100, and brought into the position illustrated on FIG. 1, the outer shell 5 is moved, preferably pushed manually, in the mating direction M.

To facilitate the moving of the outer shell 5 with respect to the inner shell 3, the outer surface 17 of the inner shell 3 is provided with linear projections 59 extending along the mating direction M, over at least half of the extension D2 along the mating direction M of the inner shell 3. The linear projections 59 are arranged in corresponding linear cams 61 formed in the inner surface 15 of the outer shell 5. Thus, when the outer shell 5 is moved with respect to the inner shell 3, the outer shell 5 can slide in a smooth and guided manner along the outer surface 17 of the inner shell 3.

When the outer shell 5 is slid along the cams 61 in the mating direction M relative to the inner shell 3, the first linear gear 29 also moves and mating direction M and engages with the first set 41 of external gear teeth. As the outer shell 5 moves in the mating direction M, the gear wheel 7 is rotated around its hinge shaft 33 in a clockwise direction O, in a rack-and-pinion configuration in which the first linear gear 29 is configured as rack, and the gear wheel 7 is configured as pinion follower. With the clockwise rotation O of the gear wheel 7, the second set 45 of external gear teeth engages with the second linear gear 105 on the other side of the gear wheel 7. Thus as the gear wheel 7 rotates in clockwise direction O, the second set 45 of teeth applies the coupling force in a direction opposed to the mating direction M on the second linear gear 105, pulling the mating connector 100 towards the connector 1. The increased first pitch radius R1 with respect to the second pitch radius R2 (see FIG. 2A) provides advantageous force transmission for the coupling force applied on the outer shell 5 on the mating connector 100.

The advantageous force transmission is particularly important in electrical connector applications involving a plurality of electrical terminals, in which the required coupling force is cumulative with respect to the number of electrical terminals. However, the advantageous force transmission can also be important in alternative embodiments in which the connector is not an electrical connector, for example instead a hydraulic connector. In the case of a hydraulic connector system the coupling system needs to overcome the sealing force of sealing structures configured to render the connector system watertight.

FIG. 3A (as well as 3B and 3C) shows both the first set 41 and the second set 45 gear teeth of the gear wheel 7, their respective engagements with the first linear gear 29 the second linear gear 105, and the cut-out regions 55a, 55b, 55c of the gear wheel 7. In addition, FIG. 3A shows the backside 63 of the depression 53 formed in the gear wheel 7, and shows partially the protrusion 65 formed on the outer surface 17 of the inner shell 3 that is configured to be received in the depression 53 in a default, uncoupled, delivery state. The protrusion 65 is more clearly visible on FIGS. 3B and 3C.

In FIG. 3A, the initial frictional resistance due to the friction fit of the protrusion 65 lodged in the depression 53 has been overcome by the pushing of the outer shell 5. The gear wheel 7 is already dislodged out of the stable delivery state, and rotated clockwise O.

In FIG. 3B, the distal edge 37 of the connector 1 has abutted on the abutment 103 of the mating connector 100. Thus, the movement of the outer shell 5 with respect to the inner shell 3, and the movement of the gear wheel 7 acting as pinion with respect to the first linear gear 29 acting as rack, have reached the end of their ranges. The outer shell 5 is in the coupled position, and the connector system 200 is in a fully coupled the state, as all electrical terminals are contacting as intended.

However, the connector 1 can be uncoupled from the mating connector 100 by mere pulling of the outer shell 5 in a direction opposed to the mating direction M, or even by excessive vibration. The connector system is, in FIG. 3B, thus not locked. The CPA 19 is in an unlocked position with respect to the outer shell 5. In order to lock the connector system 200, the CPA 19 is moved, for example by manual push on the actuation grip 25, from the unlocked position along the mating direction M further into the pocket 21 until the locking nose (not visible) can lock with or behind the locking notch 27, establishing a form fit. When the form fit is established, the CPA 19 is in the locked position. FIG. 3C illustrates the connector of FIG. 1 in a coupled and locked state, in which the CPA 19 is in the locked position.

The herein described connector 1, and the connector system 200, provide an improved connector coupling solution with reduced size. The greater compactness of the presently disclosed coupling solution may be particularly suitable for space-constrained or tight environments.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. Connector configured to be coupled in a mating direction with a mating connector, the connector comprising:
an inner shell, an outer shell, and a gear wheel, wherein:
the outer shell envelops the inner shell at least partially and is configured to be moved in the mating direction relative to the inner shell,
the outer shell comprising a first linear gear arranged along the mating direction on an inner surface of the outer shell,
the gear wheel is arranged in a rack-and-pinion configuration with the first linear gear, the gear wheel being hinged on the inner shell rotatably with respect to a hinge axis orthogonal to the mating direction, and
the gear wheel comprising a first set of external gear teeth configured to engage with the first linear gear in the rack-and-pinion configuration and a second set of external gear teeth configured to engage with a second linear gear of the mating connector, wherein the first set and the second set of external gear teeth are arranged in a same plane.

2. Connector according to claim 1, wherein the first pitch radius of the first set of external gear teeth is different from the second pitch radius of the second set of external gear teeth.

3. Connector according to claim 2, wherein the first pitch radius is between 1.2 and five times greater than the second pitch radius.

4. Connector according to claim 1, wherein the external gear teeth of the first set and the external gear teeth of the second set have at least one of the same pitch angle and/or the same circular thickness and/or the same face width.

5. Connector according to claim 4, wherein the external gear teeth of the first set and the external gear teeth of the second set have the same dimensions.

6. Connector according to claim 1, wherein the gear wheel comprises at least one cut-out region, wherein the cut-out region is comprised in an angular region of the gear wheel between the first set of external gear teeth and the second set of external gear teeth.

7. Connector according to claim 1, wherein the inner shell is configured to mate to a housing element of the mating connector, the inner shell comprising a recess extending along the mating direction, the recess being configured to receive the second linear gear of the mating connector when the inner shell is mated with the housing element such that the second set of external gear teeth engage with the second linear gear.

8. Connector according to claim 1, wherein the gear wheel comprises at least one gear teeth flap.

9. Connector according to claim 1, wherein the gear wheel comprises a first flap in an angular region of the gear wheel corresponding to the first set of external gear teeth and a second flap in the angular region of the gear wheel corresponding to the second set of external gear teeth on an opposing side with respect to the first flap.

10. Connector according to claim 1, wherein the outer shell is configured to be moved relative to the inner shell from a first, uncoupled position to a second position, in which the connector is coupled to the mating connector, and
the inner shell comprises a protrusion formed on an outer surface of the inner shell on which the gear wheel is hinged, and
the gear wheel comprises a depression matching the protrusion and configured to receive the protrusion in the first position.

11. Connector according to claim 1, wherein the ratio of the first pitch radius over the second pitch radius corresponds to the ratio of the number of external gear teeth in the first set over the number of external gear teeth in the second set.

12. Connector according to claim 1, wherein the inner shell or the outer shell comprises a linear cam extending along the mating direction, and wherein the other one of the inner shell and the outer shell further comprises a projection configured as a corresponding cam follower for the linear cam, and wherein the moving of the outer shell relative to inner shell comprises a sliding of the projection along the linear cam.

13. Connector system comprising:
a connector including an inner shell, an outer shell, and a gear wheel, wherein the outer shell envelops the inner shell at least partially and is configured to be moved in a mating direction relative to the inner shell, the outer shell comprising a first linear gear arranged along the mating direction on an inner surface of the outer shell, the gear wheel being arranged in a rack-and-pinion configuration with the first linear gear, the gear wheel being hinged on the inner shell rotatably with respect to a hinge axis orthogonal to the mating direction, and the gear wheel comprising a first set of external gear teeth configured to engage with the first linear gear in the rack-and-pinion configuration and a second set of external gear teeth, wherein the first set and the second set of external gear teeth are arranged in a same plane; and
a mating connector configured to be coupled to the connector in the mating direction, the mating connector comprising a housing element configured to mate to the inner shell, the housing element comprising a second linear gear formed on an outer surface of the housing element, the second linear gear being configured to engage with the second set of external gear teeth of the gear wheel when the connector and the mating connector are coupled.

14. Connector system according to claim 13, wherein the first pitch radius of the first set of external gear teeth is different from the second pitch radius of the second set of external gear teeth.

15. Connector system according to claim 13, wherein the external gear teeth of the first set and the external gear teeth of the second set have at least one of the same pitch angle and/or the same circular thickness and/or the same face width.

16. Connector system according to claim 13, wherein the gear wheel comprises at least one cut-out region, wherein the cut-out region is comprised in an angular region of the gear wheel between the first set of external gear teeth and the second set of external gear teeth.

17. Connector system according to claim 13, wherein the inner shell comprises a recess extending along the mating direction, the recess being configured to receive the second linear gear of the mating connector when the inner shell is mated with the housing element such that the second set of external gear teeth engage with the second linear gear.

18. Connector system according to claim 13, wherein the gear wheel comprises a first flap in an angular region of the gear wheel corresponding to the first set of external gear teeth and a second flap in the angular region of the gear wheel corresponding to the second set of external gear teeth on an opposing side with respect to the first flap.

19. Connector system according to claim 13, wherein the outer shell is configured to be moved relative to the inner shell from a first, uncoupled position to a second position, in which the connector is coupled to the mating connector, and
the inner shell comprises a protrusion formed on an outer surface of the inner shell on which the gear wheel is hinged, and
the gear wheel comprises a depression matching the protrusion and configured to receive the protrusion in the first position.

20. Connector system according to claim 13, wherein the inner shell or the outer shell comprises a linear cam extending along the mating direction, and wherein the other one of the inner shell and the outer shell further comprises a projection configured as a corresponding cam follower for the linear cam, and wherein the moving of the outer shell relative to inner shell comprises a sliding of the projection along the linear cam.
